(19) United States
(12) Patent Application Publication
(10) Pub. No.: US 2025/0171291 A1
(43) Pub. Date: May 29, 2025

(54) AUTOMATED CLEAN-IN-PLACE UNIT, A SYSTEM OF SUCH CLEAN-IN- PLACE UNITS, METHODS AND USES THEREOF

(71) Applicant: SUBD APS, Hvidovre (DK)

(72) Inventors: Finn Peder Jegård, Brøndy Strand (DK); Kenneth Peter Kolind FRANCKE, Copenhagen Ø (DK)

(21) Appl. No.: 18/873,230

(22) PCT Filed: Apr. 3, 2023
(86) PCT No.: PCT/EP2023/058609

§ 371 Date: Dec. 9, 2024

(30) Foreign Application Priority Data
Jun. 10, 2022 (DK) PA 2022 70313
Feb. 20, 2023 (DK) PA 2023 70091

(51) Int. Cl. B67D 1/07; B67D 1/04; B67D 1/08

(52) U.S. Cl. CPC B67D 1/07; B67D 1/0462; B67D 1/0837; B67D 2001/075

(57) ABSTRACT

An automated Clean-In-Place unit (4;41) is configured for cleaning at least one beverage dispensing line (DL) between a take-off station and a dispensing station of a beverage dispensing system. The automated Clean-In-Place unit (4;41) comprises a keg coupler, a cleaning coupler and/or a coupling unit (3) consisting of said couplers mounted to or mountable to any of a keg (1) containing the beverage (15), to a compressible beverage container, or to both the keg (1) and the compressible beverage container, said keg coupler, cleaning coupler and/or coupling unit (3) consisting of said couplers has at least one coupler inlet (24a; 24b) and at least one coupler outlet (28). The automated Clean-In-Place unit (4;41) comprises a control valve (20) comprising an outlet port (23) arranged to provide fluid communication with the at least one coupler inlet (24a; 24b), a first inlet port (19) arranged to provide fluid communication with a source of ozonated water (18), and optionally a second inlet port (22) arranged to provide fluid communication with a source of pressurized gas (21).

The present invention concerns an automated Clean-In-Place unit of the kind being configured for cleaning at least one beverage dispensing line between a take-off station and a dispensing station of a beverage dispensing system, wherein the automated Clean-In-Place unit comprises a keg coupler, a cleaning coupler and/or a coupling unit consisting of said couplers mounted to or mountable to any of a keg containing the beverage, to a compressible beverage container, or to both the keg and the compressible beverage container, said keg coupler, cleaning coupler and/or coupling unit consisting of said couplers has at least one coupler inlet and at least one coupler outlet.

In some embodiments the present invention concerns an automated Clean-In-Place unit of the kind comprising a keg coupler mounted to a keg containing a beverage and being configured for cleaning at least a beverage dispensing line connected to said keg coupler; said keg coupler has the at least one coupler inlet and the at least one coupler outlet.

In particular the present invention concerns an automated Clean-In-Place unit for cleaning dispensing lines of a draught beer system comprising multiple take-off receptacles in form of beer kegs and a dispensing station comprising multiple faucets arranged in a dispensing tower.

Bacteria may spoil unpasteurized keg beer or other kinds of beverages. So to maintain a quality draft beer system, it's important to clean its parts regularly. Conventionally, this will mean disassembling and reassembling the keg coupler to the keg and the cleaning systems a lot of times and with regular intervals during which the dispensing is out of operation. However the intervals of which containers and associated dispensing lines for beverages must be cleaned may depend on many different factors.

Commercially available cleaning agents are caustic chemicals that remove organic material from the interior of the draught beer dispensing line, hardware and fittings. The removal of this buildup prevents growth of beer-spoiling bacteria such as lactobacillus, pediococcus and pectinatus. A typical caustic chemical is sodium hydroxide, potassium hydroxide or a combination of both. Some caustic line cleaning solutions add EDTA or another chelating agent to help remove calcium oxalate (beer stone) from draught beer dispensing lines. Acidic chemicals can also remove inorganic materials such as calcium oxalate and calcium carbonate (water stone) from the interior of the draught beer dispensing line, hardware and fittings. Acid-based dispensing line cleaners suitable for draught beer dispensing line cleaning contain solutions of phosphoric acid, but exclude hydrochloric acid that corrodes stainless steel, and nitric acid that is not compatible with nylon products.

Both caustic and acidic chemicals are used warm at a temperature of about 26° C. and 38° C. and must remain in contact with the draught line, thus at least the dispensing line and the keg coupler, for at least 15 minutes during which the chemical solution is being re-circulated, and 20 minutes for static, or pressure pot cleaning.

Due to the hazardous chemicals draught beer dispensing line cleaning should only be performed by trained personnel. Personal protection equipment including rubber gloves and eye protection must be used whenever handling such harsh cleaning chemicals. Material Safety Data Sheets must be observed to avoid rapid increase in temperature when mixing chemicals, to thereby avoid violent and dangerous spattering or eruption of the mixed chemicals.

Other dispensing line cleaning devices to be mentioned to clean draught beer dispensing lines are electrical or sonical cleaning devices, but these are not suitable substitutes for chemical line cleaning. Although some sonic cleaning devices may inhibit bacteria and yeast growth, they make little or no cleaning effect on draught beer tapping hardware and fittings.

The above commercially available systems, methods and cleanings agents all suffer from many disadvantages.

It is therefore a main aspect of the present invention to provide an automated Clean-In-Place unit.

It is another aspect of the present invention to provide an alternative system and method of cleaning and/or disinfecting one or more dispensing lines between a take-off station and a dispensing station.

It is another aspect of the present invention to provide a system and method of cleaning and/or disinfecting one or more dispensing lines between a take-off station and a dispensing station that is/are environmentally friendly.

It is another aspect of the present invention to provide a system and method of cleaning and/or disinfecting one or more dispensing lines between a take-off station and a dispensing station with minimum human interaction.

It is another aspect of the present invention to provide a system and method of cleaning and/or disinfecting one or more dispensing lines between a take-off station and a dispensing station that reduces staff work.

It is another aspect of the present invention to provide a system and method of cleaning and/or disinfecting one or more dispensing lines between a take-off station and a dispensing station, which system and method reduce the chance of human error that can contribute to an unsafe cleaning.

It is another aspect of the present invention to provide a system and method of cleaning and/or disinfecting one or more dispensing lines between a take-off station and a dispensing station, which system and method eliminate, or at least substantially reduce, chemical exposure to humans.

It is another aspect of the present invention to provide a system and method of cleaning and/or disinfecting one or more dispensing lines between a take-off station and a dispensing station, which system and method minimize the time in which the dispensing lines are off.

It is another aspect of the present invention to provide a system and method of cleaning and/or disinfecting one or more dispensing lines between a take-off station and a dispensing station, which method system and exclude the use of conventional harsh chemicals, such as conventional caustic chemical, e.g. sodium hydroxide, potassium hydroxide or a combination of both, conventional acidic chemicals, e.g. phosphoric acid, and chelating agents.

It is another aspect of the present invention to provide a system and method of cleaning and/or disinfecting one or more dispensing lines wherein the cleaning agent is produced substantially concurrent with it being spend, thus on demand.

It is another aspect of the present invention to provide a unit and method of cleaning and/or disinfecting one or more dispensing lines between a take-off station and a dispensing station, which unit and method is reliable and repeatable.

It is another aspect of the present invention to provide a unit and method of cleaning and/or disinfecting one or more draught beer dispensing lines without having to dismantle components of the dispensing line of the beverage dispensing system before starting the method and the use of the automated Clean-In-Place unit, or the use of the system comprising several automated Clean-In-Place units, or the use of a system comprising one automated Clean-In-Place unit for several beverage containers.

It is another aspect of the present invention to provide a unit and method of cleaning and/or disinfecting food dispensing lines, production lines for drugs, pharmaceuticals and similar/other dispensable products vulnerable to contamination and bacterial growth.

Within the context of the present invention the term “keg” means a container or barrel constructed of stainless steel, aluminum, plastic or a combination of those materials. Depending on the embodiment of the present invention the term “keg” thus means both the rigid container that in itself contains the beverage, such as the older conventional beer kegs, or the rigid container that acts as a pressure chamber and contains a compressible beverage container that contains the beverage to be dispensed, such as the outer container of e.g. the Bag-in-Keg™ and Technology the DraughtMaster Technology of Carlsberg.

Within the context of the present invention the term “compressible beverage container” means a bag or pouch suitable for holding the beverage and being able to be compressed in response to an exterior force on the wall of the “compressible beverage container” to expel the beverage through the associated dispensing line.

Within the context of the present invention the term “keg coupler” or “coupling unit” means a “connector valve” or “combination of connector valves” for connecting a dispensing line to a beverage container, optionally via a keg valve or fitting on said beverage container, for controlling the introduction of gas into a keg and the resulting release of the beverage, such as beer, through the dispensing line to the user. Thus in one embodiment the “keg coupler” is a valve means inserted between the dispensing line and the beverage container, and being configured to allow beverage to be forced out of a conventional keg by the introduction of gas into the keg. In another embodiment the “keg coupler” is a valve means inserted between the dispensing line and the beverage container, and being configured to allow beverage to be forced out of a compressible beverage container inside the keg, due to the accumulating gas pressure in the gap between the compressible beverage container and the keg, inside which the compressible beverage container is installed, thus for controlling the introduction of gas into a keg, or into the gap between the compressible beverage container and the keg, inside which the compressible beverage container is installed, and the release of a beverage, such as beer, out of a keg or out of the compressible beverage container and into the dispensing line during dispensing of the beverage.

Within the context of the present invention the term “cleaning coupler” means an intermediate “connector valve” combinable with or combined with the keg coupler to facilitate connection to the automated Clean-In-Place unit, and being compatible with a “keg coupler”, “keg valve” and/or “fitting”. One cleaning coupler may be universal for all keg couplers and fittings, or cleaning couplers may be customized to fit the structural design of a particular keg coupler and/or fitting.

The terms “coupling unit” or “coupling unit consisting of said couplers” means that the keg coupler and the cleaning coupler are one integral coupling unit having the combined functionality of both said couplers and being configured for connecting or being connectable to both the beverage dispensing system and the automated Clean-In-Place system.

The keg coupler, cleaning coupler or the coupling unit connects to a source of compressed gas, such as CO₂, via a compressed gas conduit whereby compressed gas or compressed air respectively, enters the keg or the gap and pushes out the beverage, e.g. displaces beer from a beer keg or from a compressible beverage container. The keg coupler, cleaning coupler or the coupling unit may attach to a keg valve or fitting at the top of the keg or at the compressible beverage container, respectively, thereby enabling the pressurized gas or air to flow into the side of the keg through a gas conduit from e.g. a CO₂ or nitrogen tank, or air from a compressor means. The keg coupler, cleaning coupler or the coupling unit may mate sealingly as a key inside the keg valve or other kind of fitting, and when the pressurized gas or pressurized air is forced into the keg or the gap, respectively, said gas or air displaces the beverage making said beverage to flow out through the dispensing line to the tapping faucet.

It is emphasized that the present invention is not limited to be used to disinfect draught beer dispensing lines. The present invention is applicable for disinfecting any kind of dispensing system, including but not limited to systems for dispensing other draught beverages, such as draught wine, soft drinks, and draught water, as well as dispensing systems in factory environment, such as tapping systems for dairy products, pharmaceutical, cosmetics, and almost any kind of fluid, liquid, viscous or creamy products.

Within the context of the present invention the term “Clean-In-Place (CIP)” means automated or semi-automated cleaning of in particular the interior surfaces of components including at least one of a part of the keg coupler, the dispensing lines, such as one or more of pipes and hoses, vessels, equipments, filters and other associated fittings, such as keg valves with a dispensing line needed for obtaining an operational beverage dispensing system, without major disassembling of such components and substantial removing of such components from their location of use.

The above aspects, and other aspects, are achieved by the present invention in that the automated Clean-In-Place unit comprises a control valve comprising
an outlet port arranged in fluid communication with the at least one coupler inlet, and
a first inlet port arranged in fluid communication with a source of ozonated water.

The cleaning coupler may be detachably or permanently fixed to any of the keg coupler and the dispensing line, or be an integral part of the keg coupler.

The control valve may be part of any of the keg coupler, the cleaning coupler and/or the coupling unit consisting of said couplers, or be separate from said keg coupler, cleaning coupler and/or coupling unit. Thus within the scope of the present invention the control valve may be exterior to said keg coupler, cleaning r and/or coupling unit for easy maintenance.

In an embodiment of the automated Clean-In-Place unit according to the present invention the control valve may be a three-way further comprising a second inlet port arranged to provide fluid communication with a source of pressurized gas to provide either pressurized gas to displace a beverage from a keg containing the beverage, or using compressed air or compressed gas to compress a compressible beverage-containing container within a keg.

In another embodiment of the automated Clean-In-Place unit according to the present invention the control valve may be a two way-valve wherein the first inlet port is arranged to in turns provide fluid communication with a source of ozonated water and with a source of pressurized gas to this way provide pressurized gas to displace a beverage from a keg containing the beverage, or provide pressurized gas or air to compress a compressible beverage-containing container within a keg.

The control valve controls whether ozonated water and pressurized air should be allowed to pass through said control valve, out of the outlet port, and into the keg coupler, cleaning coupler or the coupling unit via the coupler inlet. Ozonated water and/or pressurized gas or pressurized air may be supplied to the keg coupler, cleaning coupler or the coupling unit simultaneously or in turns while the coupler outlet is open, and the passage to the keg or to the compressible beverage container is closed. The ozonated water then cleans, optionally disinfects, the flow path through at least the dispensing line attached to the coupler outlet, optionally cleans more or less of the keg coupler, cleaning coupler or the coupling unit, and the flow path through the tap or faucets, without the need of any keg coupler and/or separate cleaning devices having to be assembled and/or dismantled as in conventional keg cleaning system, and without the use of harsh chemicals. Injection of pressurized gas, such as air, nitrogen or CO₂, or pressurized air, may be made before and/or after flushing with ozonated water to force deposits free of adherence to surfaces, and to displace such deposits, so that the ozonated water eventually can complete cleaning/disinfection. The cleaning/disinfection may have a final pressurized gas or pressurized step. The air flushing pressurized gas or pressurized air used for cleaning the dispensing line may simply be the same gas source as the gas source used to displace beverage out of the keg or out of the compressible beverage container.

In a highly advantageous embodiment the source of ozonated water can be an electrolytic ozone generator configured to produce ozonated water from a source of water. The source of water may be directly available to the electrolytic ozone generator, e.g. by said electrolytic ozone generator being connected to a source of tap water, to thereby directly and continuously deliver tap water to the reaction chamber of the electrolytic ozone generator. In the alternative the source of water for producing ozonated water can be a batch of water, such s a batch of demineralised or sterile water, e.g. contained in a water tank in liquid communication with the reaction chamber of the electrolytic ozone generator.

Thus the electrolytic ozone generator is conveniently configured to automatically produce ozonated water promptly on demand.

By means of the electrolytic ozone generator the highly efficient cleaning and/or disinfecting agent ozone can be produced directly by the automated Clean-In-Place unit, and be kept in a closed system at all time, as a minimum when in operation and between operations. Only in case of maintenance of the automated Clean-In-Place unit some dismantling may occasionally be required.

A further huge advantage obtained by producing ozone using the electrolytic ozone generator is that it is possible to quickly achieve a much higher concentration of dissolved ozone in water than if ozone gas is bubbled into water.

In the latter case of mixing ozone gas from a pressure cylinder with water the obtainable concentration of dissolved gaseous ozone for a reasonable start-up of such a cleaning system would be at least 15 min, but typically it would take much longer before the ozone gas is mixed homogenously into a batch of water, at which stage the ozone concentration in the batch of ozonated water made by bubbling through and mixing, may be able to reach a maximum concentration of 2 ppm, which concentration is considered insufficient to clean and/or disinfect a single beverage dispensing line in a reasonable time of maximum 30 minutes. Furthermore production of ozonated water stops when the ozone gas cylinder is empty. The ozone gas cylinder must be replaced before the cleaning system is up and running again, which replacement is heavy, time consuming work, and imposes increased risk of direct contact with ozone gas. Equipment required for dissolving ozone gas into water is not required within the scope of the present invention, and handling and storing ozone gas cylinders are not needed, neither is precautions needed as is required when storing compressed health-impairing gasses, such as ozone gas.

By using the electrolytic ozone generator ozonated water can be provided quickly on demand, as the required dissolved ozone concentration in the electrolytically produced ozonated water is instantaneously, few created within seconds, thus substantially in real time and substantially concurrent and synchronous with it being spend during cleaning/disinfecting.

Further, the concentration of ozone in the ozonated water produced by the electrolytic ozone generator can reach levels much higher than 2 ppm, such as from 2-15 ppm, within few seconds.

The control valve, e.g. the three-way valve, may in some embodiments be configured for being coupled directly to a beverage containing keg, to the beverage containing keg via a keg coupler, directly to a fitting on the compressible beverage container, and/or to the fitting on the compressible beverage via an intermediate coupler, optionally the cleaning coupler, to establish fluid communication between the keg and/or the compressible beverage container to the dispensing line in a dispensing mode. In an advantageously alternative embodiment the control valve may be in fluid communication with the keg coupler, the cleaning coupler and/or the coupling unit consisting of said couplers via a separate external conduit.

The control valve may be implemented in or integral with a component, such as the cleaning coupler, or the keg coupler or be separate therefrom. The fitting may be the keg valve and any flanges associated therewith.

In an embodiment of the present invention the control valve may further be configured for closing off the dispensing mode to thereby close the fluid communication between the keg and/or the compressible beverage container and an associated dispensing line, and to establish a cleaning mode with fluid communication between at least one of the keg coupler, the fitting and/or the associated dispensing line, and one or both of the source of ozonated water and the source of pressurized gas at the same time, or in turns.

The keg coupler, the cleaning coupler or a single coupling unit consisting of said couplers may be configured with a main body that accommodates an outlet member. The outlet member is conveniently arranged to reciprocate as a piston inside the main body between a lower position, in a beverage dispensing mode, in which access to the beverage in the keg or compressible beverage container is open and beverage in the keg or in the compressible beverage container can be dispensed via the coupler outlet, and an upper position, in a cleaning mode, in which access to the beverage in the keg or compressible beverage container is closed and ozonated water can flow from the source of ozonated water, e.g. an electrolytic ozone generator that can produce ozonated water on demand, and/or pressurized gas can access the dispensing line via any of the keg coupler, the cleaning coupler or the coupling unit consisting of said couplers, whereby ozonated water and/or pressurized gas can be dispensed via the coupler outlet.

In the lower position the second inlet port and the outlet port of the control valve are both open to supply pressurized gas(es) or pressurized air to the keg to displace the beverage from inside the keg or compressible beverage container out of the coupler outlet and into the dispensing line, e.g. when the tapping faucet is opened.

The outlet member may have a central conduit arranged to dispense the beverage from the keg or compressible beverage container and a traverse cleaning conduit alignable upon reciprocation of said outlet member in relation to the main body to pass in and out of fluid communication with any of the source of ozonated water via the first inlet port or the pressurized gas via the second inlet port. When the traverse flow conduit is moved out of said alignment no matter can pass through it, and accidental access of ozonated water in the dispensing mode cannot take place. Instead the beverage in the keg or compressible beverage container can flow out of the coupler outlet at the top of the outlet member. The control valve may be arranged upstream the coupler inlet, seen in the flow direction of ozonated water and pressurized gas, in the case where the control valve is a component separate from the above-mentioned couplers, thus before the ozonated water reaches the keg coupler, the cleaning coupler and/or a coupling unit consisting of said couplers. In the alternative the control valve can be integrated in the keg coupler, the cleaning coupler or the coupling unit consisting of said couplers and be arranged upstream the traverse flow conduit.

Advantageously the automated Clean-In-Place unit may comprise means for reciprocating the outlet member along its lengthwise axis between the lower and upper positions. The means for reciprocating the outlet member may include or be an actuator, and optionally a spring means that in the lower position of the outlet member, in the dispensing mode, is compressed, and in the upper position, in the cleaning mode, applies a spring force to a seat of the keg valve or fitting.

Within the scope of the present invention an “actuator” is a device that achieves physical movements by converting energy, often electrical, pneumatic, or hydraulic, into mechanical force. Thus the “actuator” is the component that enables movement of the outlet member.

The actuator may in one embodiment be a motorized, electrical powered, linear actuator providing a travel of the outlet member up and down in relation to the keg or compressible beverage container. The travel length may differ depending on at least the travel distance required for opening the keg valve or fitting to obtain access to the interior of the keg or compressible beverage container to dispense the beverage, and closing the keg valve or fitting to stop dispensing beverage and enter cleaning mode.

The actuator can in another embodiment be a pneumatic actuator, e.g. the Compact cylinder, double-acting ADN-S, commercially available from Festo A/S, Islevdalvej 180, DK-2610 Rødovre, or be any corresponding technology that can move the outlet member up and down.

The outlet member of the keg coupler, the cleaning coupler or the coupling unit consisting of said couplers of the present invention is moved by the actuator, thus not moved up and down manually as the outlet members of the keg couplers of the prior art. Accordingly, the keg coupler, the cleaning coupler or the coupling unit consisting of said couplers of the present invention do not need a lever for this purpose. Thus the exterior design of the keg coupler, the cleaning coupler or the coupling unit consisting of said couplers of the present invention is less bulky, and independent on manual interaction for coupling to the keg or to a keg holding a compressible beverage container, and for dismantling the keg and the compressible beverage container.

The automated Clean-In-Place unit of the present invention may advantageously comprise an electronic control means configured to operate at least the control valve to open and close the ports of the control valve, optionally operate the actuator, depending on whether dispensing line(s) and/or coupler(s) are to be cleaned with ozonated water, optionally with pressurized air or pressurized gas(es), or beverage are to be dispensed when subjected to displacement from the keg or compressible beverage container by suitable injection of pressurized air, optionally pressurized gas. The electronic control means may control one or more of opening and closing of the ports of the control valve, the travel of the outlet member, and the opening and closing of the coupler inlet and coupler outlet. The electronic control means may comprise a PLC, a PCB and/or any advanced electronic computer system enabling a user to make input to the automated Clean-In-Place unit to shift between dispensing mode and cleaning mode from a remote position.

A graphical user interface on a PC-screen or tablet may be provided for user interaction with the electronic control means for the respective automated Clean-In-Place unit(s), or for user interaction via a central control unit for controlling at least one Clean-In-Place automated unit, preferably controlling respective electronic control means of several individual automated Clean-In-Place units associated with or allocated to each their keg and/or compressible beverage container, and/or for monitoring the automated Clean-In-Place unit(s) and the status of the kegs and/or the compressible beverage container.

In the alternative one common control unit may control the function of several automated Clean-In-Place units not having individual electronic control means, in which case the respective control valves may be connected to the dispensing line(s) via a manifold.

An outlet member may advantageously have a lower end configured to, in the dispensing mode, mate sealingly into a seat of the keg valve or fitting wherein the spring means is compressed and held compressed by the actuator. The lower end of the outlet member may optionally mate any keg coupler mounting device provided on or fitted on the keg and/or compressible beverage container to establish fluid communication to the beverage inside the keg or compressible beverage container for dispensing said beverage.

The present invention further concerns a method of cleaning a beverage dispensing line (DL), which method comprises an ozonated water flushing step.

Preferably the ozonated water is produced by an electrolytic ozone generator from a source of water, optionally the source of water is tap water or a batch of water, such as a batch of demineralised or sterile water.

In a preferred embodiment of the method according to the present invention the ozonated water can be produced on demand.

Preferably, at least after an initial ozonated water start-up production, the ozonated water can be produced concurrent and simultaneous with the spending of the produced ozonated water, thus on demand, so that a consistent and reliable cleaning and/or disinfection can be completed fast, whereby downtime of a beverage dispensing line can be kept at a minimum.

A preferred concentration of dissolved ozone in the electrolytically produced ozonated water is a substantially constant concentration, such as a concentration between 2-15 ppm, to thereby ensure the fast and reliable cleaning and/or disinfection of at least the dispensing line of the beverage dispensing flow path.

The method of the present invention may use the Clean-In-Place unit discussed and described above.

The keg coupler, the cleaning coupler and/or a coupling unit consisting of said couplers of the present invention can maintain stationary on the keg and/or compressible beverage container, irrespective of the keg coupler, cleaning coupler and/or a coupling unit consisting of said couplers being in dispensing mode or cleaning mode. The keg coupler, cleaning coupler and/or a coupling unit consisting of said couplers need not be dismantled of the keg and/or compressible beverage container to perform cleaning, as is the case for conventional units or systems for cleaning beverage dispensing lines. A further advantage is that the cleaning can take place at any convenient moment.

Should it happen anyway that ozonated water accidentally, optionally unobserved, admix into the beverage, concentrations will be very small, and it has no harmful effect on flavors and potential capability of beer to foam, nor does this create health issues. Ozone in water will deteriorate quickly and is not harmful to human in such huge dilutions.

In one embodiment of the Clean-In-Place unit, due to the close coupling between the seat and the lower end of the outlet member in the dispensing mode, ozonated water residues from the cleaning mode cannot get mixed with the beverage. The tight fit of the outlet member in the seat effectively prevents such contamination. It may be preferred to provide suitable sealing gaskets at the seat and around the outlet member to further prevent leakage of any fluid, such as ozonated water into the beverage inside the keg or inside the compressible beverage container in the dispensing mode.

The main body of the keg coupler, cleaning coupler and/or a coupling unit consisting of said couplers may have a coupling flange configured to couple to any of a keg valve, a neck flange part of the keg and/or to a spear coupling flange. As a keg valve, the neck flange part of the keg and/or the spear coupling e may come in many different designs, keg couplers, cleaning coupler and/or a coupling unit consisting of said couplers having matingly designs of coupling flanges may be provided within the scope of the present invention. Thus the respective coupling flange(s) of the coupler(s) of the present invention may be configured similar to any conventional keg coupler to fit various known coupling systems, for instance the systems known to the skilled person, such as the D System (Sankey keg coupler for the USA), U System, S System (European Sankey coupler), A System (the German Slider coupler designed for use with German beers), G System (Used for UK brands of beer), M System (slides over the top of the keg; mostly for German beers), and KeyKeg (The KeyKeg or K System) that is a rather new system for keg tapping that uses single-use plastic kegs and displacement of beer by compressing beer in a plastic bag using the exterior force of pressurized air or pressurized gas(es) on the plastic bag wall.

The automated Clean-In-Place unit of the present invention may include an adapter to interface between a keg coupling flange and any of the keg valve, the neck flange part of the keg and/or the spear coupling making one keg coupler, cleaning coupler and/or a coupling unit consisting of said couplers universal to many different kinds of keg valve systems, fittings and spears coupling flanges.

The invention also relates to a Clean-In-Place system comprising at least two Clean-In-Place units of the kind described above. The Clean-In-Place system may further comprise an ozonated water manifold to distribute ozonated water to one or more Clean-In-Place units of the at least two Clean-In-Place units in the cleaning mode, and a pressurized gas or pressurized air manifold to distribute pressurized gas or pressurized air to the one or more Clean-In-Place units of the at least two Clean-In-Place units in the dispensing mode. The ozonated water manifold and the pressurized gas or pressurized air manifold may be utilized as the same by implementing various valves.

The individual electronic control means of automated Clean-In-Place units can in some embodiment be external to the keg coupler, the cleaning coupler and/or the coupling unit consisting of said couplers, and be placed or arranged in any other suitable location or position, such as the manifold(s).

All individual electronic control means of a system of several automated Clean-In-Place units, the associated control valves, and other required valves may be placed in any other related location associated with such system. All individual electronic control means of a system of several automated Clean-In-Place units and the associated control valves may e.g. be located in relation to the above-mentioned manifold(s).

The present invention will be described below with reference to the drawing in which the invention is illustrated by way of principle sketches.

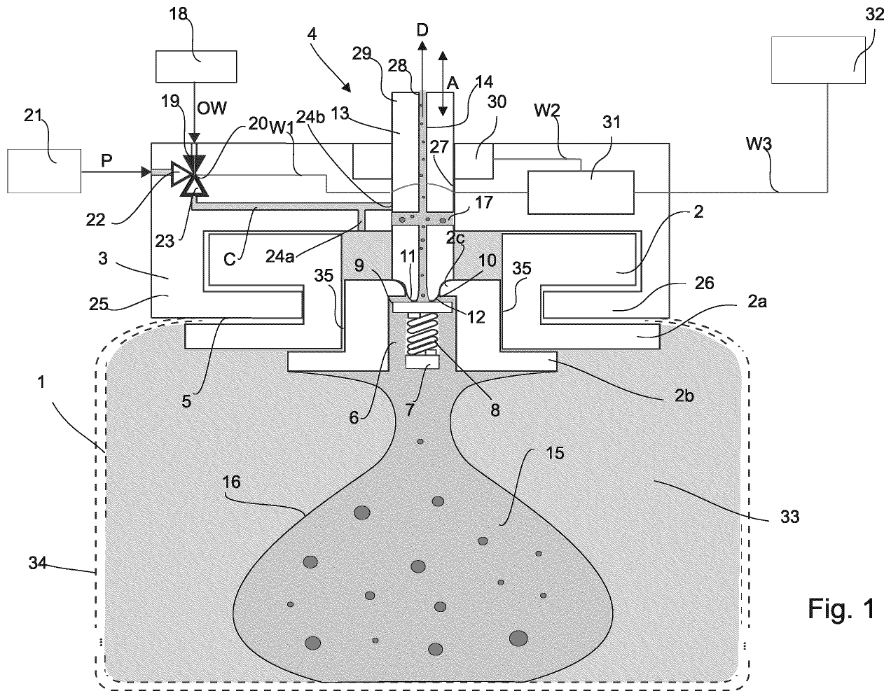

FIG. 1 is a principle sketch of a single Clean-In-Place unit mounted on a KeyKeg and shown in dispensing mode,

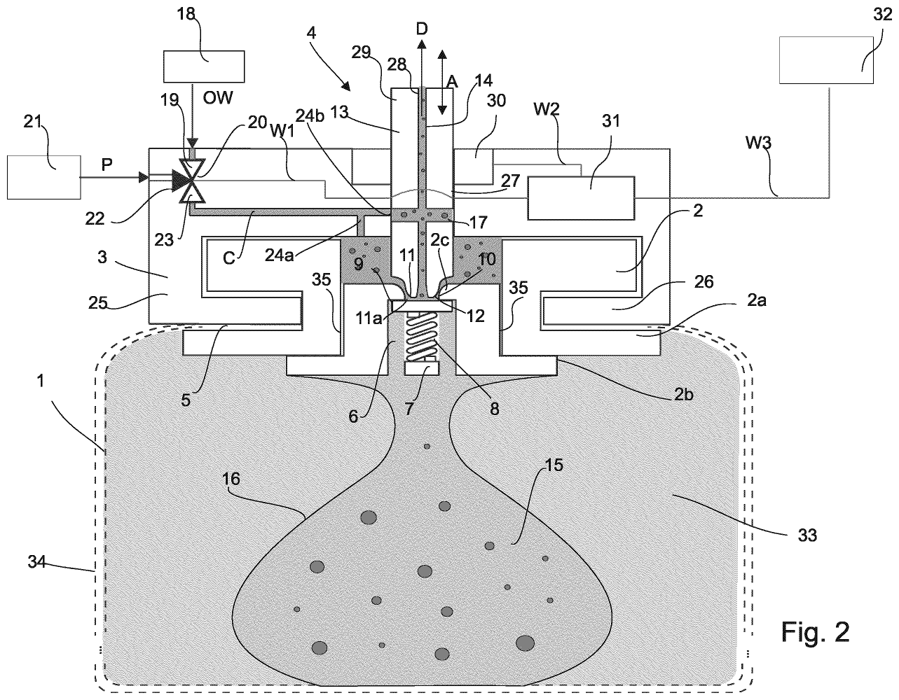

FIG. 2 shows the same in cleaning mode,

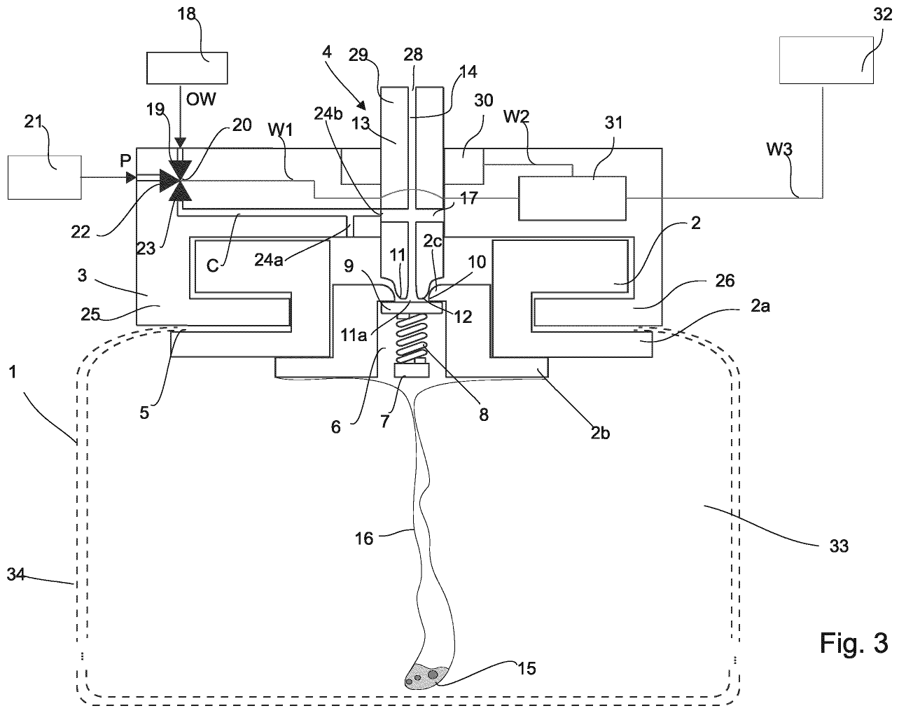

FIG. 3 shows the same in a keg replacement mode,

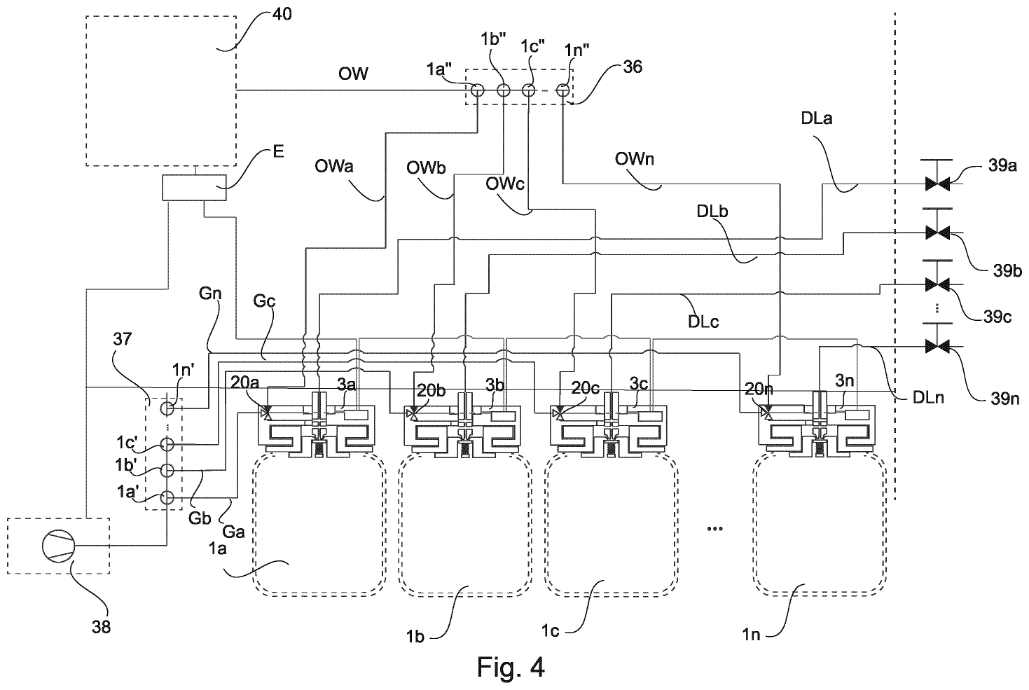

FIG. 4 shows n KeyKegs of the kind shown in FIGS. 1-3 being connected in parallel to an ozone manifold and in parallel to a pressurized gas manifold, and with the KeyKegs in the dispensing mode seen in FIG. 1,

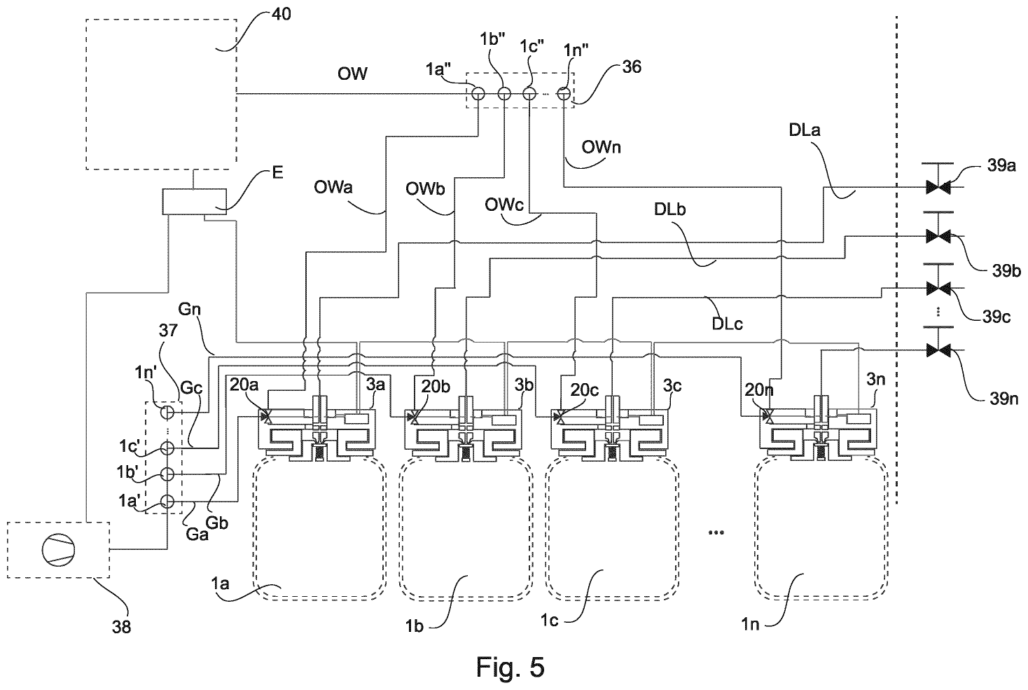

FIG. 5 shows the same but in the cleaning mode,

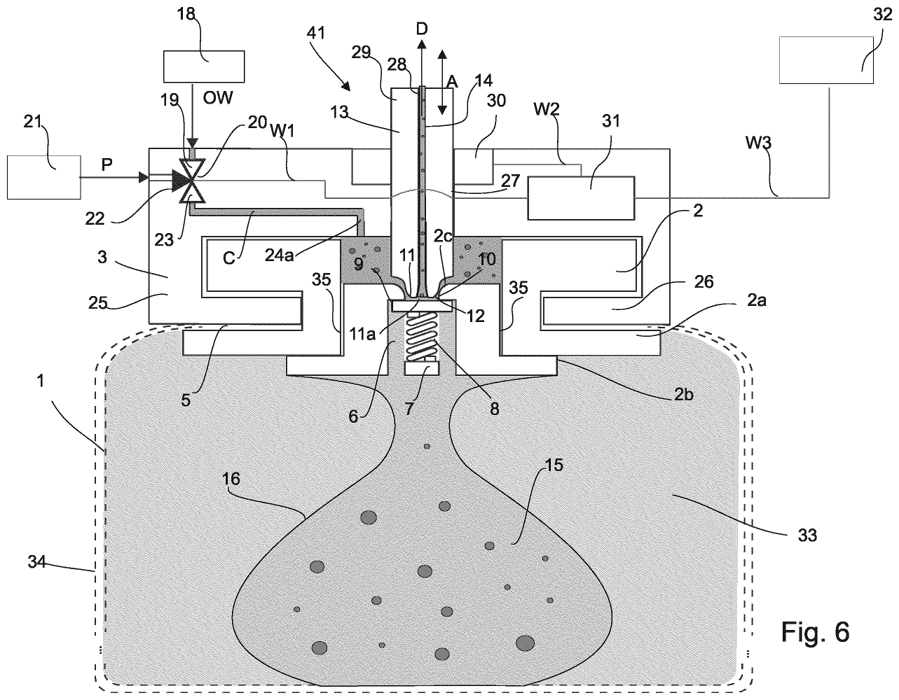

FIG. 6 shows a modified single Clean-in-Place unit in cleaning mode, and

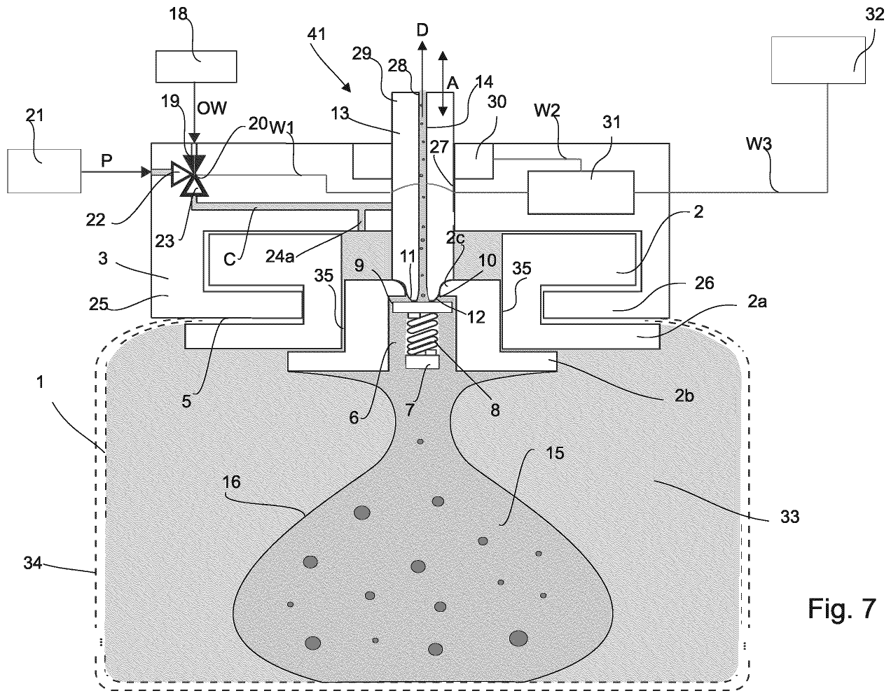

FIG. 7 shows the modified Clean-in-Place unit in dispensing mode.

In the figures the keg 1 is exemplified as a KeyKeg, (the Bag-in-Keg™ Technology) the dimensions which be of may disproportionate in relation to the coupling unit 3 in order to better illustrate the main components of the automated Clean-In-Place unit 4 of the present invention, as well as the interaction between the components of the automated Clean-In-Place unit of the present invention. Emphasize is made that the keg 1 may be both wider and higher than shown in the figures, and be of another kind of keg, e.g. a conventional beer keg with a spear and CO₂ injected into the beer to displace the beer out of the keg.

The control valve is by way of example shown and described as being a three-way valve, however embodiments implementing two-way valves, combinations of several valves, or other means that in a similar manner can be used to open and close between cleaning mode and dispensing mode are foreseen within the scope of the present invention.

A KeyKeg 1 has a fitting 2 for securing of a coupling unit 3 that comprises a keg coupler with the integrated functionality of the cleaning coupler. For general purpose the fitting is denominated a keg valve 2. Keg couplers and coupling units for any design of fitting is foreseen within the scope of the present invention.

The keg valve 2 has a neck flange part 2a and a keg valve part 2b. The neck flange part 2a is secured to the keg 1 at its keg opening 5, and said neck flange part 2a surroundingly accommodates the keg valve part 2b. The keg valve part 2b has a central bore 6 inside which a spring means 7 is arranged. The spring means 7 includes a compression spring 8 with an upper head 9. The central bore 6 has an upper bore opening 10 configured as a seat 11 for a lower end 12 of an outlet member 13 of the coupling unit 3. The upper bore opening 10 is delimited by lip member 2c. The outlet member 13 is in the following referred to as a probe 13 and is in sealed fluid communication with a dispensing line (not shown). The probe 13 has a central conduit 14 arranged to dispense the beverage 15 from the beverage containing plastic bag 16 located inside the keg 1. The functionality of the cleaning coupler of the coupling unit 3 is in this embodiment obtained due to the probe further having a traverse cleaning conduit 17 alignable upon reciprocation of said probe 13 in relation to a main body 25 of the coupling unit 3 and in relation to the keg valve 2, as indicated by double arrow A, to pass in and out of fluid communication with any of the source of ozonated water 18 via a first inlet port 19 of a three-way valve 20 or pressurized gas 21 via a second inlet port 22 of the three-way valve 20.

The three-way valve 20 further has an outlet port 23 arranged to provide fluid communication with any of a first coupler inlet branch 24a or a second coupler inlet branch 24b via a conduit C. In the present case branches 24a, 24b and conduit C are shown integrated in a main body 25 of the coupling unit 3. Also the three-way valve 20 are shown integrated in the main body 25 of the coupling unit 3, but the three-way valve 20 may in many configurations be a separate unit to be coupled in fluid communication with the branches 24a, 24b, conduit C, and/or be exterior to the cleaning coupler.

The main body 25 has a coupling flange 26 configured to couple sealingly to the keg valve 2. The main body 25 has a main bore 27 to be at least substantially aligned with the central bore 6 of the keg valve 2, and to reciprocatingly accommodate the probe 13. The coupler outlet 28 is provided at the free end 29 of the probe 13.

An actuator 30, such as an electric motor or other linear actuator, drives the required travel of the probe 13 up and down inside the main bore 27 to open and close the seat 11 against the keg valve part 2b, and to open and close for fluid communication between the traverse cleaning conduit 17 and the second coupler inlet branch 24b of the conduit C. The movement of the probe 13 induced by the actuator 30, and the operation of the three-way valve 20, are controlled by an electronic control means 31 connected to a power supply 32 by means of electric wires W1, W2, W3.

In the dispensing mode seen in FIG. 1 the probe 13 is held by the actuator 30 in a lower position, and the traverse cleaning conduit 17 is in offset position in relation to the second coupler inlet branch 24b of conduit C, which second coupler inlet branch 24b thereby has been blocked by the body of the probe 13, so that ozonated water OW cannot pass into the traverse cleaning conduit 17 and further into the central conduit 14.

In the dispensing mode seen in FIG. 1 the second inlet port 22 and the outlet port 23 of the three-way valve 20 are both open and in fluid communication with the first coupler inlet branch 24a to allow pressurized gas, e.g. CO₂ or N₂, or pressurized air, or mixtures thereof, to be injected via conduit C, as indicated by arrow P, into the space 33 between the exterior wall 34 of the keg 1 and the compressible beverage container, thus the beverage bag 16, e.g. a compressible beer-containing plastic bag 16 specially configured for the keg 1 and being secured at its bag opening to the keg valve part 2b. The pressurized gas or pressurized air passes via circumferentially spaced apart openings 35 between the neck flange part 2a and the keg valve part 2b into the space 33 to compress the plastic bag 16, thereby displacing the beverage up through the central conduit 14, out of the coupler outlet 28 and into a dispensing line (not shown), as indicated by arrow D. The first inlet port 19 of the three-way valve 20 is closed so that no ozonated water can contaminate the beverage.

In FIG. 1 the beverage is indicated by bobble graphic, and the pressurized gas and the ozonated water is indicated by different coloring. As the components are shown in purely functional principle only, no hatching of any components is appropriate. Furthermore, the position of the three-way valve 20 shown in the figures relative to the main body 25 should not be construed as limiting the scope of the present invention, nor should any dimensions.

FIG. 2 is a principle sketch of the automated Clean-In-Place unit 4 seen in FIG. 1 but in the cleaning mode. In the cleaning mode the first inlet port 19 and the outlet port 23 of the three-way valve 20 are open and the second inlet port 22 is closed.

The actuator 30 has placed the probe 13 in its upper position. The spring means 7 applies a spring force to the seat 11 of the keg valve 2 whereby the upper head 9 abuts the seat 11 to sealingly close the upper bore opening 10. In this position of the upper head 9 no ozonated water can enter the beverage 15. The ozonated water passes from the outlet port 23 into the conduit C having the second coupler inlet branch 24b aligned with the traverse cleaning conduit 17, thereby allowing the ozonated water to pass into said traverse cleaning conduit 17 and further into the central conduit 14, as well as into the first coupler inlet branch 24a and into the main bore 27 between the lower end 12 of the probe 13 and the upper head 9 to rise against the central conduit 14. From the central conduit 14 the ozonated water flows into the dispensing line (not shown) and out via the tapping faucet (not shown) and into a drain (not shown) where ozone deteriorates at no harm to human beings. All surfaces contacted by the ozonated water will in this way be cleaned and disinfected. The electronic control means may allow a residence time for the ozonated water to react to disinfect said surfaces before the faucet at the end of the dispensing line is opened. During cleaning the faucet may be connected to a drain tube, e.g. via an elastic push-on fitting or via a snap coupling.

In the cleaning mode seen in FIG. 2 the coupling unit 3 and the dispensing line (not shown) may be blown free of deposits and/or ozonated water by opening the second inlet port 22 and closing the first inlet port 19. An opening 35, which is provided by a circumferential space or gap, e.g. between the neck flange part 2a and the keg valve part 2b, are firmly sealed in the cleaning mode in that the spring means forces the neck flange part 2a against the keg valve part 2b.

In an alternative embodiment the opening 35 can also be provided in a lower part of the probe 13, which lower part can be rotated in relation to an upper part to open and close said opening 35, while still keeping control of the potential alignment and offset of the traverse cleaning conduit 17 and with the conduit C and the first coupler inlet branch 24a and the second coupler inlet branch 24b.

The electronic control means may conduct one or more cleaning cycles in form of a sequence of repetitive alternating flushings and/or dwell times of selected ozonated water and/or pressurized gas.

durations with

In the keg replacement mode seen in FIG. 3 all ports 19, 22, 23 of the three-way valve 20 and the coupler outlet 28 are closed and the probe 13 is in its upper position. The plastic bag 16 has been compressed and is almost empty of beverage. The space 33 has been degassed or de-aired. There is a need for a new keg 1, or a new full plastic bag 16 to be provided inside a reusable keg 1. To do so the coupling unit 3 of the present invention is simply dismantled the keg valve 2 and placed on a new full keg 1 or the new full plastic bag 16 is places inside the reusable keg 1, that serves as the pressure chamber. Dismantling can take place by means of sliding, pulling or screwing the coupling unit 3 apart from the keg valve 2.

Due to the presence of the three-way valve 20 the coupling unit 3 does not need a further valve means at the coupler inlet 24a, 24b.

FIG. 4 shows n KeyKegs 1a, 1b, 1c, . . . , In of the kind shown in FIGS. 1-3, all being in the dispensing mode seen in FIG. 1. Each keg la, 1b, 1c, . . . , In is connected in parallel to an ozonated water manifold 36 and a gas manifold 37, said gas manifold 37 has n gas manifold outlets 1a′, 1b′, 1c′, . . . , 1n′. In the dispensing mode of FIG. 4 pressurized gas or pressurized air to the gas manifold 37 is provided by compressor 38 and supplied to the second inlet port 22 of a respective three-way valve 20 (see FIG. 1) via respective gas conduits Ga, Gb,

Gc, . . . , Gn to expel the beverage via respective dispensing lines DLa, DLb, DLC, . . . , DLn and out of respective tapping faucets 39a, 39b, 39c, . . . , 39n at a take off station.

The ozonated water manifold 36 has n ozonated water manifold outlets 1a″, 1b″, 1c″, . . . , 1n″, and in the cleaning mode seen in FIG. 5 the ozonated water manifold 36 receives ozonated water OW from a source of ozonated water 40, such as an electrolytic ozone generator that produces ozonated water on demand, and distributes said ozonated water OW via ozonated water conduits Owa, Owb, Owc, . . . , Own to the respective three-way 20a, 20b, 20c, . . . , 20n of the associated corresponding coupling units 3a, 3b, 3c, . . . , 3n of the n KeyKegs 1a, 1b, 1c, . . . , 1n under the general control of an electronic control unit E that communicates with at least the respective electronic control means. The first inlet port 19, the outlet port 23 and the coupler outlet 28 are open, but the coupler inlet are closed, as also illustrated and described in relation to FIG. 2.

The electronic control unit E is configured to operate one or more of the coupling units 3a, 3b, 3c, . . . , 3n of the kegs 1a, 1b, 1c, . . . , 1n in any of the dispensing mode and the cleaning mode, which is seen in FIG. 5, such as the electronic control means 31 of each keg 1a, 1b, 1c, . . . , 1n, and thus also the respective actuators and the movement of probes, opening and closing of the ports of the three-way valves and of the coupler inlet and coupler outlet, as well as the production and supply of ozonated water, and controlling the ozonated water manifold and the gas manifold. Due to the kegs are arranged in parallel when connected to the ozonated water manifold the electronic control unit E can then place one or more kegs in dispensing mode while the rest of the kegs are in cleaning mode, in operation, or out of operation. One dispensing line can be cleaned alone, and several dispensing lines can be cleaned at the same time.

The electronic control unit E is electrically coupled to any component of the automated Clean-In-Place unit 4 of the present invention by means of electrical wires; however Bluetooth operation may be adopted if appropriate.

For ease of overviewing, FIGS. 4 and 5 are shown without indications of beverage, ozonated water and pressurized gas.

FIG. 6 shows a single modified Clean-in Place-unit 41 in the cleaning mode. The modified Clean-In-Place unit 41 corresponds substantially to the afore-mentioned Clean-in Place-unit 4 and for like parts same reference numerals are used.

The modified Clean-in Place-unit 41 differs from the afore-mentioned Clean-in Place-unit 4 in that the outlet member 13 does not have a traverse cleaning conduit 17 that needs to be aligned with a second coupler inlet branch 24b of a control valve upon reciprocation of the outlet member 13 in relation to the main body 25 in order for conducting flushing with ozonated water.

In the cleaning mode seen in FIG. 6 the actuator 30 has placed the probe 13 in its upper position whereby the neck flange part 2a and the keg valve part 2b are brought into sealing contact so that ozonated water is prevented from getting into the opening 35 between the neck flange part 2a and the keg valve part 2b, and further into the space 33 between the exterior wall 34 of the keg 1 and the beverage bag 16. Simultaneously therewith the spring means 7 applies a spring force to the upper head 9 so that said upper head 9 abuts against the lip member 2a so that the upper bore opening 10 is sealed against the compressible beverage container 16. In this position of the upper head 9 no ozonated water can enter the beverage 15.

The ozonated water follows a path where it passes from the outlet port 23 into the conduit C, and further towards and into the gap 11a between the seat 11 and the upper head 9 to proceed up into the central conduit 14, wherefrom the ozonated water flows into the dispensing line to clean and/or disinfect the dispensing line (not shown) as described above.

In the dispensing mode seen in FIG. 7 of the modified Clean-In-Place unit 41 the actuator 30 has placed the probe 13 in its lower position, and the seat against the upper head 9, whereby the neck flange part 2a and the keg valve part 2b are brought free of sealing contact by the actuator 30, similar to the dispensing mode seen in FIG. 1. The seat 11 closes against the upper head 9 whereby the pressurized gas or pressurised air can be injected via conduit C. The lip member 2c and the upper head 9 are sealed against each other so that pressurized gas cannot enter central conduit 14 in the dispensing mode. The pressurized gas or pressurized air accesses the space 33 between the exterior wall 34 of the keg 1 and the beverage bag 16 via conduit C and via the opening 35 between the neck flange part 2a and the keg valve part 2b, to compress said beverage bag 16.

As for the first embodiment of a Clean-in-Place unit 4, for the modified Clean-in-Place unit 41 the three-way valve 19 also controls the various modes and the movement of the probe 13.

Emphasise is made that the modified Clean-in-Place unit 41 can be implemented in series in a similar manner as the Clean-In-Place unit 4, as shown in FIGS. 4 and 5.

All components that might come in contact with ozonated water are made of ozone resistant material(s). The concentration of ozone in the ozonated water may vary depending on the need for cleaning and the cleaning frequency, however the inventors of the present invention have established that the optimum concentration of dissolved ozone in the ozonated water for disinfection of draught beer dispensing lines is between 2 and 15 ppm. Preferably said concentration of dissolved ozone is at least 3 ppm, preferably at least 5 ppm, or at least 8 ppm, or at least 10 ppm. 6 ppm may be preferred for most kinds of beer dispensing lines, however fruity or very sweet inhomogeneous or turbid beers types may require higher concentrations cleaning and disinfecting the dispensing line.

By using the Clean-in-Place units, and/or Clean-in-Place system and/or methods one dispensing line can be fully cleaned and/or disinfected in about 10 minutes, contrary to when using a conventional cleaning system, which takes up to an hour. By means of the present invention two or more dispensing lines can be cleaned at the same time or at different times.

In one or more embodiment of a Clean-In-Place unit or Clean-In-Place system a first further valve (not shown), such as a shut-off valve, may be inserted in a supply line for the ozonated water between the source of ozonated water and the control valve, to further ensure that the supply, and stopping of the supply, of ozonated water can be controlled further. The first further valve may be coupled in electronic communication with the electrolytic ozone generator, to automatically start or stop the ozonated water production, e.g. in response to a signal from an electronic control means or an electronic control unit to open or close said first further valve. The first further valve may serve as a safety precaution means to be closed in connection with change of keg(s).

Similarly a second valve (not shown), such as an further further shut-off valve may conveniently be inserted in the conduit C to further ensure that the supply, or stopping of supply, of ozonated water can be controlled even further, as well at the supply and stopping of the supply of pressurized gas(es) or pressurized air can be controlled. Also the second further valve may be coupled in electronic communication with the electrolytic ozone generator as well as the source of pressurized gas(es) or pressurized air, to start and stop the ozonated water production and/or the injection of pressurized gas(es) or pressurized air in response to opening and closing said second further valve. The second further valve may serve as a safety precaution means to be closed in connection with change of keg(s).

1. An automated Clean-In-Place unit configured for cleaning and disinfecting at least one beverage dispensing line (DL) between a take-off station and a dispensing station of a beverage dispensing system, wherein the automated Clean-In-Place unit comprises a coupling unit consisting of a keg coupler and a cleaning coupler, which coupling unit is mounted to or mountable to a keg that acts as a pressure chamber and contains a compressible beverage container that contains the beverage to be dispensed, said coupling unit has at least one coupler inlet and at least one coupler outlet, wherein
in a beverage dispensing mode said at least one coupler inlet and said at least one coupler outlet is not in fluid communication, and
in a cleaning mode said at least one coupler inlet and said at least one coupler outlet is in fluid communication,
wherein the automated Clean-In-Place unit comprises a control valve comprising
an outlet port arranged in fluid communication with the at least one coupler inlet, and
a first inlet port arranged in fluid communication with a source of ozonated water,
wherein the source of ozonated water is an electrolytic ozone generator configured to produce ozonated water from a source of water, wherein the concentration of dissolved ozone in the produced ozonated water for disinfection of the at least one beverage dispensing line is between 2-15 ppm.

2. An automated Clean-In-Place unit according to claim 1, wherein the control valve is a three-way valve further comprising a second inlet port arranged to provide fluid communication with a source of pressurized gas.

3. An automated Clean-In-Place unit according to claim 1, wherein the control valve is a two way-valve, wherein the first inlet port is arranged to in turns provide fluid communication with a source of ozonated water and with a source of pressurized gas.

4. An automated Clean-In-Place unit according to claim 1, wherein the control valve is part of any of the coupling unit consisting of the keg coupler and the cleaning coupler, or is separate from said coupling unit.

5. An automated Clean-In-Place unit according to claim 1, wherein the source of water is tap water or a batch of water, such as a batch of demineralised demineralized or sterile water.

6. An automated Clean-In-Place unit according to claim 5, wherein the electrolytic ozone generator is configured to automatically produce ozonated water on demand.

7. An automated Clean-In-Place unit according to claim 1, wherein the control valve is configured for coupling directly to the keg via the keg coupler, directly to a fitting on the compressible beverage container, and/or to the fitting on the compressible beverage container via an intermediate coupler, optionally the cleaning coupler or the coupling unit, to establish fluid communication between the compressible beverage container and the dispensing line (DL) in a dispensing mode.

8. (canceled)

9. An automated Clean-In-Place unit according to claim 1, wherein the coupling unit has a main body accommodating an outlet member, which outlet member is arranged to reciprocate as a piston inside the main body between a lower position in which access to the beverage in the compressible beverage container is open so that beverage in the compressible beverage container can be dispensed via the coupler outlet, and an upper position in which access to the beverage in the compressible beverage container is closed, and ozonated water and/or pressurized gas can access the dispensing line via any of the coupling unit, whereby ozonated water and/or pressurized gas is dispensed via the coupler outlet.

10. An automated Clean-In-Place unit according to claim 9, wherein the outlet member has a central conduit arranged to dispense the beverage from the keg or the compressible beverage container.

11. An automated Clean-In-Place unit according to claim 10, wherein the central conduit is arranged in fluid communication with the source of ozonated water.

12. An automated Clean-In-Place unit according to claim 10, wherein the central conduit is arranged in fluid communication with the source of pressurized gas or air.

13. An automated Clean-In-Place unit according to claim 9, wherein the outlet member has a traverse cleaning conduit alignable upon reciprocation of the said outlet member in relation to the main body to pass in and out of fluid communication with any of the source of ozonated water via the first inlet port or the pressurized gas via the second inlet port.

14. An automated Clean-In-Place unit according to claim 9, wherein the automated Clean-In-Place unit comprises means for reciprocating the outlet member along its lengthwise axis.

15. An automated Clean-In-Place unit according to claim 14, wherein the means for reciprocating the outlet member includes an actuator for reciprocating the outlet member along its lengthwise axis.

16. An automated Clean-In-Place unit according to claim 14, comprising an electronic control means configured to control one or more of opening and closing of the ports of the control valve, the travel of the outlet member, the means for reciprocating the outlet member, and the opening and closing of the coupler inlet and coupler outlet.

17. An automated Clean-In-Place unit according to claim 16, wherein the electronic control means comprises a PLC, a PCB and/or a computer system configured for enabling a user to make input to the automated Clean-In-Place unit to shift between a dispensing mode and a cleaning mode from a remote position without dismantling any components of the beverage dispensing system.

18. An automated Clean-In-Place unit according to claim 1, comprising a graphical user interface configured for user interaction with a central control unit for controlling at least one automated Clean-In-Place unit.

19. An automated Clean-In-Place unit according to claim 18, wherein the central control unit controls respective electronic control means of several individual automated Clean-In-Place units associated with or allocated to each their beverage container, and/or monitors the automated Clean-In-Place unit(s) and the status of the compressible beverage containers.

20. An automated Clean-In-Place unit to claim 9, wherein the outlet member has a lower end configured to mate sealingly into a seat of a fitting of a compressible beverage container within a keg.

21. An automated Clean-In-Place unit according to claim 20, wherein the lower end of the outlet member is configured to compress and relieve a spring means in response to said outlet member being reciprocated along the lengthwise axis of said outlet member.

22. Use of an automated Clean-In-Place unit according to claim 1 for cleaning and disinfecting at least one beer dispensing line of a beer dispensing system.

23. A method of cleaning and disinfecting a beverage dispensing line (DL), which method comprises an ozonated water flushing step, wherein the ozonated water is produced by an electrolytic ozone generator from a source of water, wherein the concentration of dissolved ozone in the produced ozonated water for cleaning and disinfecting the beverage dispensing line is between 2-15 ppm.

24. A method according to claim 23, wherein the source of water is tap water, or a batch of water, such as a batch of demineralized or sterile water.

25. A method according to claim 23, wherein the ozonated water is produced on demand, preferably produced at least after an initial ozonated water start-up production to achieve a start-up concentration of ozone in the produced ozonated water, optionally ozonated water is produced concurrent and simultaneous with the spending of said produced ozonated water.

26. A method according to claim 24, utilizing the automated Clean-In-Place unit.

27. A Clean-In-Place system comprising at least two Clean-In-Place units according to claim 1, comprising an ozonated water manifold, and optionally a pressurized gas or air manifold.

28. A Clean-In-Place system according to claim 27, wherein respective electronic control means associated with each of the at least two Clean-In-Place systems can be operated via a central control unit that comprises control software, optionally via a graphical user interface configured for user interaction with said control software.

29. A Clean-In-Place system according to claim 28, wherein the control software comprises monitoring software for monitoring at least the status of the at least two automated Clean-In-Place units, the status of the beverage containers, and the status of the method as defined in any of the preceding claims.

30. Use of the Clean-In-Place system as defined in claim 27 in a draught beer dispensing system.
